(19) United States
(12) Patent Application Publication
(10) Pub. No.: US 2023/0313589 A1
(43) Pub. Date: Oct. 5, 2023

(54) METHOD FOR OPERATING A FLAP ARRANGEMENT OF A MOTOR VEHICLE

(71) Applicant: Brose Fahrzeugteile GmbH SE & Co. Kommanditgesellschaft, Bamberg, Bamberg (DE)

(72) Inventors: Heino Schalyo, Altendorf (DE); Matthias Seubert, Zeil (DE); Christoph Haberberger, Goessweinstein (DE); Philipp Konarski, Hallstadt (DE)

(21) Appl. No.: 18/126,106

(22) Filed: Mar. 24, 2023

(30) Foreign Application Priority Data
Mar. 25, 2022 (DE) 10 2022 107 047.6

(51) Int. Cl. E05F 15/611; B62D 33/027

(52) U.S. Cl. CPC E05F 15/611; B62D 33/0273; E05B 81/68; E05Y 2201/408; E05Y 2400/302; E05Y 2400/354; E05Y 2400/40; E05Y 2900/544

(57) ABSTRACT

A method for operating a flap assembly of a motor vehicle, a drive assembly for the motorized adjustment of the flap, a motor vehicle lock, and a flap sensor assembly for identifying a flap position, wherein the drive assembly has at least one drive which is restorably movement-coupled to the flap, with an electric drive motor, wherein the motor vehicle lock fixes the flap in a closed position in a main locked state, wherein the drive motor is activated by a drive control system of the drive assembly depending on the identified flap position. It is proposed that when the identified flap position reaches a predetermined braking initiation position situated before an end position in a movement procedure of the flap, the drive motor is activated in a braking routine by the drive control system in such a way that the drive assembly produces a motorized braking effect.

### CLAIM OF PRIORITY

This application claims the benefit of German Patent application No. DE 10 2022 107 047.6 filed on Mar. 25, 2022, the disclosure of which is incorporated herein by reference.

### FIELD OF THE TECHNOLOGY

Various embodiments relate to a method for operating a flap assembly of a motor vehicle, to a drive control system for operating a flap assembly of a motor vehicle, to a drive assembly for a flap assembly of a motor vehicle, and to a flap assembly for a motor vehicle.

### SUMMARY

The flap assembly in question has a flap, such as a cargo bed flap, in particular of a pick-up, which is opened and closed under the influence of gravity. The flap can likewise be configured as a tailgate, trunk lid, side door, rear door, hood, or the like. The flap can be arranged pivotably and/or displaceably on the motor vehicle body. For greater comfort, flap assemblies of motor vehicles are provided with a drive assembly which assists manual adjustment of the flap or enables automatic motorized adjustment.

Greater demands are placed on the drive assembly in terms of capacity and robustness in particular for the motorized adjustment of heavy flaps. A challenge here is to match the operation of the motorized flap assembly to different operating scenarios such as manual adjustment, motorized adjustment, and motorized assistance of manual adjustment.

Various embodiments are based on the problem of providing a method for operating a flap assembly which enables further optimization in terms of the wear and the demands on the drive assembly.

The above problem can be resolved by various features disclosed herein.

Various embodiments are based on the observation that when a sudden manual opening or closing movement is made, for example when the flap is slammed shut, high braking forces can act on the drive components. Generally, the drive coupling between the drive motor is subject to a small amount of play such that drive components “lag behind” the movement of the flap when the closing position is reached and are brought to an abrupt stop by mechanical interaction. As a result, increased wear and the risk of damage to the drive assembly occur.

Essential here is the fundamental idea of using the activation of the drive to reduce the braking forces which arise.

In detail, it is proposed that, when the identified flap position reaches a predetermined braking initiation position situated before an end position in a movement procedure, the drive motor is activated by means of the drive control system in a braking routine in such a way that the drive assembly generates a motorized braking effect.

The proposed solution thus advantageously resorts to the use of technical control means to reduce possible mechanical wear of the drive assembly. At least some of the kinetic energy of the drive components can here be converted into electrical energy and be discharged. The mechanical drive components are treated gently as a result.

In various embodiments, the reaching of the primary pre-locked state of the motor vehicle lock, in which the flap can already be fixed in place by the motor vehicle lock, can be used as the braking initiation position.

In various embodiments, the braking initiation position corresponds to the reaching of the secondary pre-locked state which in particular is also interrogated by sensors for a shutting procedure of the motor vehicle lock. This braking initiation position enables a long braking path, which is advantageous for a reliable braking routine, as far as the main locked position.

In addition, the braking routine can be performed depending on movement values of the flap, whereby the braking routine can be adapted as required or even suppressed. For example, the braking routine is performed only above a predetermined minimum speed such that the situation is avoided where the braking routine opposes the reaching of the end position of the flap during a manual adjustment.

Various embodiments relate to performance of the braking routine as required depending on different operating modes such as a manual adjustment and a motorized adjustment. The presence of the operating modes can in turn be identified depending on the already mentioned movement values.

Various embodiments relate to the adaptation of the braking routine on the basis of the movement values.

In addition to operation of the drive motor as a short-circuit brake, according to some embodiments drive power can also be applied to the drive motor counter to the direction of movement of the flap such that the motorized braking effect can be varied and in particular further strengthened.

In various embodiments, the braking initiation position is predetermined depending on the movement values such that in particular the adjustment path from the braking initiation position to the end position can be optimized.

Some embodiments relate to the flap sensor assembly.

According to various embodiments, a drive control system for operating a flap assembly of a motor vehicle is provided.

It is essential here that when the identified position of the flap reaches a predetermined braking initiation position situated before the end position in a movement procedure of the flap, the drive control system activates the drive motor in a braking routine in such a way that the drive assembly produces a motorized braking effect. Reference should be made to all explanations of the method.

According to various embodiments, a drive assembly for a flap assembly of a motor vehicle is provided, the drive assembly having at least one drive which, in the assembled state, is restorably movement-coupled to the flap, with an electric drive motor and a drive control system as proposed. Reference should be made to all explanations of the method and the drive control system.

According various embodiments, a flap assembly for a motor vehicle is provided, wherein the flap assembly is configured to perform the method as proposed. Reference should be made to all explanations of the method, the drive control system, and the drive assembly.

Various embodiments provide a method for operating a flap assembly of a motor vehicle, the flap assembly having a flap which can be adjusted via flap kinematics, a drive assembly for the motorized adjustment of the flap, a motor vehicle lock associated with the flap, and a flap sensor assembly for identifying a flap position of the flap, wherein the drive assembly has at least one drive which is restorably movement-coupled to the flap, with an electric drive motor, wherein the motor vehicle lock fixes the flap in a closed position in a main locked state, wherein the drive motor is activated by means of a drive control system of the drive assembly depending on the identified flap position, wherein when the identified flap position reaches a predetermined braking initiation position situated before an end position in a movement procedure of the flap, the drive motor is activated in a braking routine by means of the drive control system in such a way that the drive assembly produces a motorized braking effect.

In various embodiments, the braking initiation position corresponds to the reaching of a primary pre-locked state of the motor vehicle lock, which is provided to fix the flap in a partially locked position by the motor vehicle lock.

In various embodiments, the braking initiation position corresponds to the reaching of a secondary pre-locked state of the motor vehicle lock in which the beginning of a motorized shutting procedure of the motor vehicle lock via a locking auxiliary drive can be provided, wherein the motorized shutting procedure can be modified, in particular suppressed or terminated, as the braking routine is carried out.

In various embodiments, the braking routine is carried out depending on a movement criterion being met by movement values identified by means of the flap sensor assembly, in particular speed values and/or acceleration values, such as depending on the exceeding of a predetermined minimum speed.

In various embodiments, the braking routine is performed depending on an operating mode of the drive assembly, wherein, in some embodiments, the braking routine is performed when there is manual adjustment, provided as an operating mode, of the flap, wherein the braking routine is performed in a motorized assistance routine, provided as an operating mode, for manual adjustment of the flap, and/or wherein the braking routine is modified, in particular suppressed or terminated, in a motorized adjustment routine provided as an operating mode, in some embodiments, wherein the existence of manual adjustment is monitored by means of the drive control system on the basis of the movement criterion.

In various embodiments, the activation of the drive motor in the braking routine is performed depending on movement values of the flap which are identified by means of the flap sensor assembly, in some embodiments, wherein a higher motorized braking effect can be effected for higher movement values of the flap.

In various embodiments, the activation of the drive motor in the braking routine is performed by means of the drive control system by operation of the drive motor as a short-circuit brake and/or applying electric drive power to the drive motor counter to the direction of movement of the flap.

In various embodiments, the braking initiation position is predetermined depending on movement values of the flap which are identified by means of the flap sensor assembly, in some embodiments, a braking initiation position spaced further apart from the end position in a movement procedure of the flap is predetermined for higher movement values of the flap.

In various embodiments, the flap sensor assembly has at least one of: a state sensor for the motor vehicle lock, such as a pawl sensor and/or lock latch sensor; an incremental path sensor, such as a Hall effect sensor, for the flap and/or the drive; and/or a drive value sensor, such as a drive current sensor and/or a drive voltage sensor, for the drive motor.

Various embodiments provide a drive control system for operating a flap assembly of a motor vehicle, the flap assembly having a flap which can be adjusted via flap kinematics, a drive assembly for the motorized adjustment of the flap, a motor vehicle lock associated with the flap, and a flap sensor assembly for identifying a flap position of the flap, wherein the drive assembly has at least one drive which is restorably movement-coupled to the flap, with an electric drive motor, wherein the motor vehicle lock fixes the flap in a closed position in a main locked state, wherein the drive control system activates the drive motor of the drive assembly depending on the identified flap position, wherein when the identified flap position reaches a predetermined braking initiation position situated before an end position in a movement procedure of the flap, the drive control system activates the drive motor in a braking routine in such a way that the drive assembly produces a motorized braking effect.

In various embodiments, a motorized adjustment routine is provided as an operating mode in which the drive control system activates the drive motor for motorized adjustment, in particular for a motorized closing procedure, in some embodiments, wherein the drive control system performs the braking routine depending on the operating mode of the drive assembly, in some embodiments, wherein the drive control system modifies, in particular suppresses or terminates, the braking routine in the motorized adjustment routine.

Various embodiments provide a drive assembly for a flap assembly of a motor vehicle, the drive assembly having at least one drive which, in the assembled state, is restorably movement-coupled to the flap, with an electric drive motor and a drive control system as described herein.

Various embodiments provide a flap assembly for a motor vehicle, wherein the flap assembly is configured for carrying out the method as described herein.

### BRIEF DESCRIPTION OF THE DRAWINGS

Various aspects will be explained in detail below with the aid of drawings which illustrate only exemplary embodiments. In the drawings:

FIG. 1 shows the rear region of a motor vehicle with a flap assembly as proposed which is equipped with a drive assembly as proposed, and detailed views of the drive and the motor vehicle lock, and

FIG. 2 shows exemplary curves a) of the torque occurring at the drive with no braking routine, and b) of the torque occurring at the drive, and c) of the drive current with a braking routine.

### DETAILED DESCRIPTION

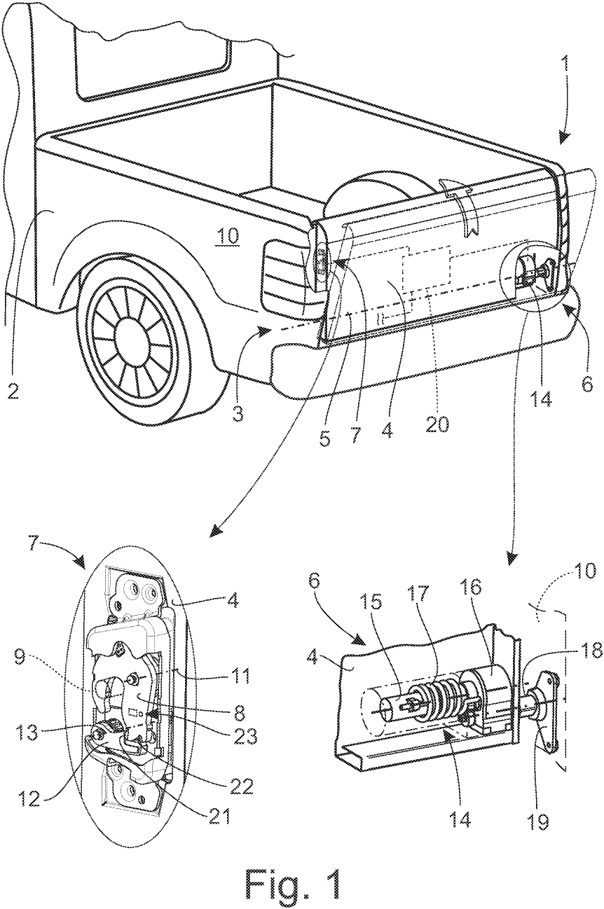

The exemplary embodiment illustrated in the Figures relates to a method for operating a flap assembly 1 of a motor vehicle 2. The flap assembly 1 has a flap 4 which can be adjusted via flap kinematics 3 between an open position (not shown) and the closed position illustrated in FIG. 1 with solid lines.

The term “flap kinematics” encompasses all the components which enable the movement of the flap 4. The flap kinematics 3 can be configured in such a way that the flap 4 can be pivoted about a geometric flap axis 5, wherein other configurations of the flap kinematics 3 are conceivable.

The motor vehicle 2 can be a pick-up, wherein the flap 4 is provided as a cargo bed flap and is arranged in such a way that a closing movement indicated by the arrow in FIG. 1 is executed partially counter to the gravity of the flap 4. In order to increase the operating comfort, a drive assembly 5 is provided for the motorized adjustment of the flap 4, wherein the drive assembly 6 can be configured to automatically adjust or alternatively assist manual adjustment of the flap 4 by the operator.

A motor vehicle lock 7 associated with the flap 4 is furthermore provided which is reproduced in FIG. 1 in a detailed view. A plurality of, in particular two, motor vehicle locks 7, which are arranged for example on opposite sides of the flap 4, can also be associated with the flap 4. The explanations of the motor vehicle lock 7 correspondingly also apply for any further motor vehicle locks 7 of the flap assembly 1.

The motor vehicle lock 7 can have a lock latch 8 for interaction with a locking part 9 which can be configured as a locking bar, locking wedge, or the like. The locking part 9 can be arranged on the body 10 of the motor vehicle 2. It is conversely also possible that the locking part 9 is arranged on the flap 4 and the motor vehicle lock 7 on the body 10.

The lock latch 8 can pivot about a geometric lock latch axis 11. The motor vehicle lock 7 moreover has a pawl 12 which can pivot about a geometric pawl axis 13. The motor vehicle lock 7 can be brought into at least one locked state, here into the main locked state, in which the lock latch 8 is fixed by retaining engagement with the pawl 12 and secures the locking part 9. In the main locked state of the motor vehicle lock 7, the flap 4 is fixed in a locked, here the completely locked position. Further locked states of the motor vehicle lock 7 are conceivable and are explained below.

A flap sensor assembly not illustrated in detail for identifying a flap position of the flap 4 is provided. The flap position should be understood as a spatial situation of the flap 4, wherein it is also sufficient if the flap sensor assembly can identify information about the assuming of at least one predetermined flap position. The flap position can here also be determined indirectly, for example via properties of the drive assembly 6 and/or the motor vehicle lock 7.

The drive assembly 6 is equipped with at least one drive 14 which is restorably movement-coupled to the flap 4. A plurality of drives 14 can here be provided, for example, on opposite sides of the flap 4. The drive 14 serves to supply a driving force and has an electric drive motor 15, here a rotating drive motor 15, and a transmission 16. In addition, a spring element 17 can be provided to supply mechanical pretension. The transmission 16 translates the rotational driving movement generated by the drive motor 15 into a rotational movement of a driven element 18. In the assembled state, the driven element 18 transmits the driving force generated by the drive 14 to a drive coupling 19 for the motorized adjustment of the flap 4.

The driven element 18 can be configured as a driving pin which engages in the drive coupling 19 in order to transmit a driving torque caused by the driving force. The drive coupling 19 is moreover configured as a body connection which is attached in the assembled state non-rotatably on the body 10 of the motor vehicle 2, whilst the drive 14 is associated with the cargo bed flap. A reverse arrangement is conceivable in which the drive 14 is associated with the body 10.

A drive control system 20 is provided which can be configured, as illustrated, as a flap control unit associated with the flap assembly 1 or as a control unit which is integrated into the drive 14 and interacts with a higher-level motor vehicle control system. Instead of this decentralized approach, the drive control system 20 can also be a constituent part of a central motor vehicle control system. The drive control system 20 has control electronics for implementing the control tasks which occur here, for example a processor and a memory with commands which effect the implementation of the method when performed on the processor.

The activation is moreover performed depending on the identified flap position. The drive control system 20 here receives from the flap sensor assembly sensor values which are used to identify the flap position and/or the drive control system 20 receives from the flap sensor assembly the already identified flap position. The flap sensor assembly can also be integrated into the drive control system 20.

It is then essential that, when the identified flap position reaches a predetermined braking initiation position situated before an end position in a movement procedure of the flap 4, the drive motor 15 is activated by means of the drive control system 20 in a braking routine in such a way that the drive assembly 6 produces a motorized braking effect.

The end position of the flap 4 can be the closed position which will be described in detail below. It is also conceivable to carry out the braking routine when a completely open position has been reached which is predetermined, for example, by a mechanical limit stop of the flap 4. All explanations of the closed position as the end position apply, where applicable, also for the open position as the end position.

The braking initiation position is reached before the end position in the movement procedure of the flap 4. In a closing procedure, starting from the open position, the flap 4 passes, for example, first through the braking initiation position before reaching the closed position.

Deceleration at least of drive components of the drive 14, here for example of the driven element 18, the transmission 16, and the motor shaft of the drive motor 15, is effected by the motorized braking effect. In one embodiment, there is, between the drive assembly 6 and the flap 4, mechanical play within which the driven element 18 can be operated by the drive 14 without transmitting the driving force to the drive coupling 19, wherein the motorized braking effect is produced within the mechanical play. It is also conceivable that the drive assembly 6 acts on the flap 4 with the motorized braking effect, for example before the end position is reached.

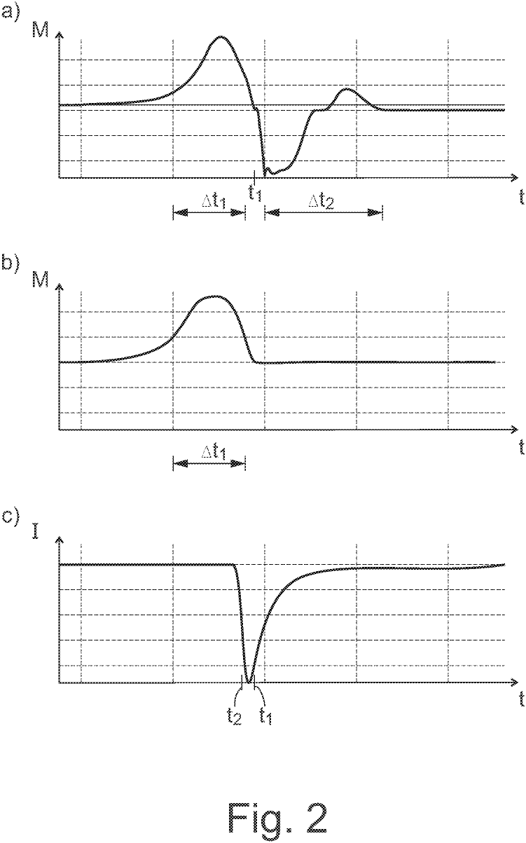

FIG. 2a) shows by way of example the curve of the torque occurring at the driven element 18 of the drive 14 as a result of the interaction with the drive coupling 19, plotted against time t, with no braking routine in the case of a manual adjustment such as slamming shut the flap 4. The flap 4 is accelerated manually during the period Δt₁. At time t₁, the flap 4 reaches the closed state and the motor vehicle lock 7 the main locked state. The drive components experience mechanical play and, during the period Δt₂, are here abruptly decelerated at the end of the play by striking one another, wherein, for example, the moments of inertia of the driven element 18, the transmission 16, and the motor shaft have to be mechanically absorbed. A high counter-torque correspondingly acts on the drive components during the period Δt₂.

FIG. 2b) then shows the curve of the torque occurring at the driven element 18 as a result of the interaction with the drive coupling 19, plotted against time t, with a braking routine. During the period Δt₁, the flap 4 is again accelerated manually and, at time t₁, the closed state is reached. When the braking initiation position is reached at time t₂, the braking routine has already begun, wherein the drive motor 15 is here operated subsequently as a short-circuit brake. The drive components are thus slowed down in such a way that only a small counter-torque occurs and a hard stop at the end of the mechanical play is avoided. Correspondingly, the slowing down is effected by the drive 14 itself and only a small torque, or none at all, occurs due to the interaction of the driven element 18 and the drive coupling 19. FIG. 2c) shows an exemplary curve of the drive current I which occurs with the operation as a short-circuit brake.

In one embodiment, it is provided that the braking initiation position corresponds to the reaching of a primary pre-locked state of the motor vehicle lock 7 in which the motor vehicle lock 7 fixes the flap 4 in a partially closed position.

The primary pre-locked state is provided between an open state and the main locked state of the motor vehicle lock 7. In the illustration in FIG. 1, the lock latch 8 is pivoted counterclockwise when the flap 4 is closed by introducing the locking part 9, wherein the pawl 12 can come into engagement with a pre-detent 21 of the lock latch 8 in order to form the primary pre-locked state. By further pivoting of the lock latch 8, the pawl 12 can in turn come into engagement with a main detent 22 of the lock latch 8 in order to form the illustrated main locked state. Other implementations of the locked states and in particular of the primary pre-locked state, for example via a plurality of pawls 12 or different detent positions on the lock latch 8, are conceivable here.

When the flap 4 closes, within the scope of the method, the pawl 12 does not necessarily have to engage with the pre-detent 21 and the primary pre-locked state does not actually have to be assumed. For example, when the flap 4 is quickly slammed shut, a position, corresponding to the primary pre-locked state, of the lock latch can be passed over without the pawl 12 engaging. Instead, just the position, here the angle of rotation, of the lock latch 8 and hence the position of the locking part 9 is predetermined by the respective locked state.

The primary pre-locked state is in many cases already detected by sensors in order to monitor the motor vehicle lock 7 such that additional sensors do not necessarily need to be provided in order to implement the braking routine.

In various embodiments, it is provided that the braking initiation position corresponds to the reaching of a secondary pre-locked state of the motor vehicle lock 7 in which the beginning of a motorized shutting procedure of the motor vehicle lock 7 via a locking auxiliary drive can be provided.

The secondary pre-locked state is here provided between the open state and the primary pre-locked state of the motor vehicle lock 7. In the secondary pre-locked state, it is not necessarily provided that the locking part 9 and thus the flap 4 can be fixed in place by the motor vehicle lock 7. Instead, the secondary pre-locked state can be provided as a state, interrogated by sensors, for triggering the motorized shutting procedure of the motor vehicle lock 7 by means of which the motor vehicle lock 7 is transferred into the main locked state by means of a locking auxiliary drive (not illustrated). The lock latch 8 and/or the locking part 9 can here be adjusted by a motor drive.

It can be provided that the motorized shutting procedure is modified, in particular suppressed or terminated, as the braking routine is carried out. It can thus be avoided that the shutting procedure and the braking routine counteract each other.

It can be provided that the braking routine is carried out depending on a movement criterion being met by movement values identified by means of the flap sensor assembly, in particular speed values and/or acceleration values, such as depending on the exceeding of a predetermined minimum speed.

The braking routine can here be carried out or not carried out or suppressed depending on whether the movement criterion has been met. Aspects of the braking routine and/or the braking initiation position can likewise be varied depending on the movement criterion being met.

In various embodiments, the braking routine is carried out only when a predetermined minimum speed is exceeded. For example, when the flap 4 is closed as usual slowly by hand, no braking routine takes place, whereas, when the flap 4 is quickly slammed shut, the braking routine is carried out in order to protect the drive 14.

It can be that the braking routine is performed depending on an operating mode of the drive assembly 6.

Manual adjustment of the flap 4 can be provided as an operating mode in which it is possible for the braking routine to be carried out in particular depending on further criteria such as the minimum speed. Manual adjustment is in particular adjustment of the flap 4 without any contribution from the drive 14.

A motorized assistance routine for manual adjustment of the flap 4 can be provided as an operating mode. Manually guided adjustment of the flap 4 can here be assisted by a motor drive, for example in order to reduce the manual forces. Ongoing motorized adjustment of the flap 4 can also be accelerated by manual intervention, as a result of which particularly quick adjustment of the flap 4 can take place. The braking routine can again here be carried out.

A motorized adjustment routine can be provided as an operating mode in which the flap 4 is adjusted by means of the drive 14 with no manual influence. The speed of the flap can here be regulated, for example, to a predetermined speed profile. The motorized adjustment routine can be configured in such a way that the occurrence of high braking forces when the end position is reached is avoided. Correspondingly, the braking routine can be modified in this operating mode, for example carried out with a diminished braking effect, or alternatively suppressed. An already active motorized adjustment routine can also be terminated.

The respective operating mode can be saved in the drive control system 20, wherein, for example, the motorized adjustment routine is triggered by activation from an operator, for example activation of a button, or alternatively by initiating manual adjustment of the flap 4. It can be provided that the existence of manual adjustment is monitored by means of the drive control system 20 on the basis of the movement criterion. If, for example, manual intervention by the operator on the flap 4 is detected in the motorized adjustment routine on the basis of the movement values, a switch can be made to one of the other operating modes such as manual adjustment or motorized assistance.

As already mentioned, it is provided in various embodiments that the activation of the drive motor 15 in the braking routine is performed depending on movement values of the flap 4 which are identified by means of the flap sensor assembly. For example, a higher motorized braking effect can be effected for higher movement values of the flap 4.

In further embodiments, it is provided that the activation of the drive motor 15 in the braking routine is performed by means of the drive control system 20 by operation of the drive motor 15 as a short-circuit brake and/or the application of electric drive power to the drive motor 15 counter to the direction of movement of the flap 4.

In particular, the braking effect dependent on the movement values is effected by such an activation of the drive motor 15.

It is furthermore provided in one embodiment that the braking initiation position is predetermined depending on movement values of the flap 4 which are identified by means of the flap sensor assembly.

By predetermining the braking initiation position, the adjustment path remaining for slowing down the drive components in the braking routine as far as the end position can be set and varied. If, for example for higher movement values of the flap 4, a braking initiation position spaced further apart from the end position in a movement procedure of the flap 4 is predetermined, the remaining adjustment path can be adapted to the respective existing movement values, in particular to the speed values.

It is furthermore provided that the flap sensor assembly can have at least one of: a state sensor 23 for the motor vehicle lock 7, such as a pawl sensor and/or lock latch sensor; an incremental path sensor, such as a Hall effect sensor, for the flap 4 and/or the drive 14; and/or a drive value sensor, such as a drive current sensor and/or a drive voltage sensor, for the drive motor 15.

The locked state of the motor vehicle 2 can be identified via the state sensor 23 for the motor vehicle lock 7, for example via the detection of the position of the lock latch 8 which allows a conclusion to be drawn about the flap position. Corresponding state sensors 23 are provided in many cases for monitoring the motor vehicle lock 7 and in particular for triggering a shutting procedure such that already present sensors can be resorted to for triggering the braking routine. The state sensor 23, such as the pawl sensor and/or the lock latch sensor, can have, for example, a microswitch and/or, as illustrated in FIG. 1, a Hall effect sensor with a Hall effect transducer for interrogating the position of locking components.

An incremental path sensor is provided, for example, on the flap 4, in particular on the components, such as hinges or the like, which implement the flap kinematics 3. The drive 14, in particular the drive motor 15, can also have an incremental path sensor. The path sensor can here already be provided to determine the flap position for activation of the drive 14 in a motorized adjustment routine.

A flap position can also be identified by means of the drive values, such as drive current and/or drive voltage, detected via the drive value sensor, wherein a motor model can be used for the identification. It is also, for example, possible to evaluate the ripple current of the drive current as a basis for identifying the flap position. The drive voltage is understood to mean the electrical voltage which is present or generated at the drive motor 15. The drive current is correspondingly understood to mean the electrical current flowing at the drive motor 15.

Various embodiments provide a drive control system 20 for operating a flap assembly 1 of a motor vehicle 2, the flap assembly 1 having a flap 4 which can be adjusted via flap kinematics 3, a drive assembly 6 for the motorized adjustment of the flap 4, a motor vehicle lock 7 associated with the flap 4, and a flap sensor assembly for identifying a flap position of the flap 4, wherein the drive assembly 6 has at least one drive 14, which is restorably movement-coupled to the flap 4, with an electric drive motor 15, wherein the motor vehicle lock 7 in a main locked state fixes the flap 4 in a closed position, wherein the drive control system 20 activates the drive motor 15 of the drive assembly 6 depending on the identified flap position.

The essential thing here is that, when the identified flap position reaches a predetermined braking initiation position situated before an end position in a closing procedure of the flap 4, the drive control system 20 activates the drive motor 15 in a braking routine in such a way that the drive assembly 6 acts on the flap 4 with a motorized braking effect.

The drive control system 20 correspondingly has control electronics which are structurally configured to implement the braking routine.

It can be furthermore provided that a motorized adjustment routine, in which the drive control system 20 activates the drive motor 15 for the motorized adjustment, in particular for a motorized closing procedure, is provided as an operating mode, such as in a way that the drive control system 20 performs the braking routine depending on the operating mode of the drive assembly 6, such as in a way that the drive control system 20 modifies, in particular suppresses or terminates, the braking routine in the motorized adjustment routine.

The operating modes already mentioned in connection with the method are here implemented by the drive control system 20.

Various embodiments provide a drive assembly 6 for a flap assembly 1 of a motor vehicle 2, the drive assembly 6 having at least one drive 14 which, in the assembled state, is restorably movement-coupled to the flap 4, with an electric drive motor 15 and a drive control system 20 as proposed.

Various embodiments provide a flap assembly 1 for a motor vehicle 2, wherein the flap assembly 1 is configured for carrying out the method as proposed.

1. A method for operating a flap assembly of a motor vehicle, the flap assembly having a flap which can be adjusted via flap kinematics, a drive assembly for the motorized adjustment of the flap, a motor vehicle lock associated with the flap, and a flap sensor assembly for identifying a flap position of the flap,
wherein the drive assembly has at least one drive which is restorably movement-coupled to the flap, with an electric drive motor, wherein the motor vehicle lock fixes the flap in a closed position in a main locked state, wherein the drive motor is activated by a drive control system of the drive assembly depending on the identified flap position,
wherein when the identified flap position reaches a predetermined braking initiation position situated before an end position in a movement procedure of the flap, the drive motor is activated in a braking routine by the drive control system in such a way that the drive assembly produces a motorized braking effect.

2. The method as claimed in claim 1, wherein the braking initiation position corresponds to the reaching of a primary pre-locked state of the motor vehicle lock, which is provided to fix the flap in a partially locked position by the motor vehicle lock.

3. The method as claimed in claim 1, wherein the braking initiation position corresponds to the reaching of a secondary pre-locked state of the motor vehicle lock in which the beginning of a motorized shutting procedure of the motor vehicle lock via a locking auxiliary drive is provided.

4. The method as claimed in claim 1,wherein the braking routine is carried out depending on a movement criterion being met by movement values identified by the flap sensor assembly.

5. The method as claimed in claim 1, wherein the braking routine is performed depending on an operating mode of the drive assembly, wherein the braking routine is performed when there is manual adjustment, provided as an operating mode, of the flap, wherein the braking routine is performed in a motorized assistance routine, provided as an operating mode, for manual adjustment of the flap, and/or wherein the braking routine is modified, in particular suppressed or terminated, in a motorized adjustment routine provided as an operating mode.

6. The method as claimed in claim 1, wherein the activation of the drive motor in the braking routine is performed depending on movement values of the flap which are identified by the flap sensor assembly.

7. The method as claimed in claim 1, wherein the activation of the drive motor in the braking routine is performed by the drive control system by operation of the drive motor as a short-circuit brake and/or applying electric drive power to the drive motor counter to the direction of movement of the flap.

8. The method as claimed in claim 1, wherein the braking initiation position is predetermined depending on movement values of the flap which are identified by the flap sensor assembly.

9. The method as claimed in claim 1, wherein the flap sensor assembly has at least one of: a state sensor for the motor vehicle lock; an incremental path sensor for the flap and/or the drive; and/or a drive value sensor for the drive motor.

10. A drive control system for operating a flap assembly of a motor vehicle, the flap assembly having a flap which can be adjusted via flap kinematics, a drive assembly for the motorized adjustment of the flap, a motor vehicle lock associated with the flap, and a flap sensor assembly for identifying a flap position of the flap,
wherein the drive assembly has at least one drive which is restorably movement-coupled to the flap, with an electric drive motor, wherein the motor vehicle lock fixes the flap in a closed position in a main locked state, wherein the drive control system activates the drive motor of the drive assembly depending on the identified flap position,
wherein when the identified flap position reaches a predetermined braking initiation position situated before an end position in a movement procedure of the flap, the drive control system activates the drive motor in a braking routine in such a way that the drive assembly produces a motorized braking effect.

11. The drive control system as claimed in claim 10, wherein a motorized adjustment routine is provided as an operating mode in which the drive control system activates the drive motor for motorized adjustment.

12. A drive assembly for a flap assembly of a motor vehicle, the drive assembly having at least one drive which, in the assembled state, is restorably movement-coupled to the flap, with an electric drive motor and a drive control system as claimed in claim 10.

13. A flap assembly for a motor vehicle, wherein the flap assembly is configured for carrying out the method as claimed in claim 1.

14. The method as claimed in claim 3, wherein the motorized shutting procedure is modified as the braking routine is carried out.

15. The method as claimed in claim 1, wherein the braking routine is carried out depending on a movement criterion being met by movement values identified by the flap sensor assembly depending on the exceeding of a predetermined minimum speed.

16. The method as claimed in claim 5, wherein the existence of manual adjustment is monitored by the drive control system on the basis of the movement criterion.

17. The method as claimed in claim 6, wherein a higher motorized braking effect can be effected for higher movement values of the flap.

18. The method as claimed in claim 8, wherein a braking initiation position spaced further apart from the end position in a movement procedure of the flap is predetermined for higher movement values of the flap.

19. The method as claimed in claim 9, wherein the state sensor for the motor vehicle lock comprises a pawl sensor and/or lock latch sensor;
wherein the incremental path sensor comprises a Hall effect sensor; and
wherein the drive value sensor comprises a drive current sensor and/or a drive voltage sensor.

20. The drive control system as claimed in claim 11, wherein the drive control system performs the braking routine depending on the operating mode of the drive assembly, and wherein the drive control system modifies the braking routine in the motorized adjustment routine.
